(19) United States
(12) Patent Application Publication
(10) Pub. No.: US 2010/0301499 A1
(43) Pub. Date: Dec. 2, 2010

(54) MOLD AND METHOD FOR MANUFACTURING FRESNEL LENS

(75) Inventor: YUNG-LUN HUANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/761,358

(22) Filed: Apr. 15, 2010

(30) Foreign Application Priority Data
May 26, 2009 (CN) 200910302642.6

(51) Int. Cl. B29D 11/00; B29C 33/10

(52) U.S. Cl. 264/1.1; 425/112

(57) ABSTRACT

A mold for manufacturing Fresnel lenses includes a carrying holder, and a mold core including a bottom side surface adjacent to the carrying holder and a top side with a molding structure, wherein the mold core further comprises a number of through holes connected between the molding structure and the bottom side surface, and the carrying holder further comprises a number of pumping holes connected with the through holes.

### BACKGROUND

1. Technical Field

The disclosure relates to a mold and, more particularly, to a mold and a method for manufacturing a Fresnel lens.

2. Description of Related Art

Fresnel lenses, which include a set of concentric annular prisms, can be formed by hot press molds. The hot press mold includes a molding surface that defines sharp-angled accesses for molding sharp-angled portions of the prisms of the Fresnel lens. A separation membrane is pasted to the molding surface of the hot press mold to increase separability of the hot press mold. However, it is difficult to make the separation membrane completely contact the molding surface, especially the sharp-angled accesses, which reduces preciseness of molding.

Therefore, it is necessary to provide a mold and a method for manufacturing a Fresnel lens using the mold to improve preciseness of molding.

### BRIEF DESCRIPTION OF THE DRAWINGS

The components in the drawing are not necessarily drawn to scale, the emphasis instead being placed upon clearly illustrating the principles of the disclosure.

FIG. 1 is an isometric, exploded view of a mold in an exemplary embodiment of the present disclosure.

FIG. 2 is a bottom view of a mold core of the mold of FIG. 1.

FIG. 3 is an isometric, partially assembled view of the mold of FIG. 1.

FIG. 4 is a cross-sectional view of the mold core and a carrying holder of the mold taken along a line IV-IV of FIG. 3.

FIG. 5 is similar to FIG. 4, but further showing a separation membrane of the mold.

FIG. 6 is similar to FIG. 5, but showing that the separation membrane fully contacts with a molding structure of the mold core.

FIG. 7 is similar to FIG. 6, but showing a melted molding material injected into the mold core.

FIG. 8 is similar to FIG. 7, but showing a Fresnel lens formed by pressing the melted molding material via a press mold plate of the mold.

### DETAILED DESCRIPTION

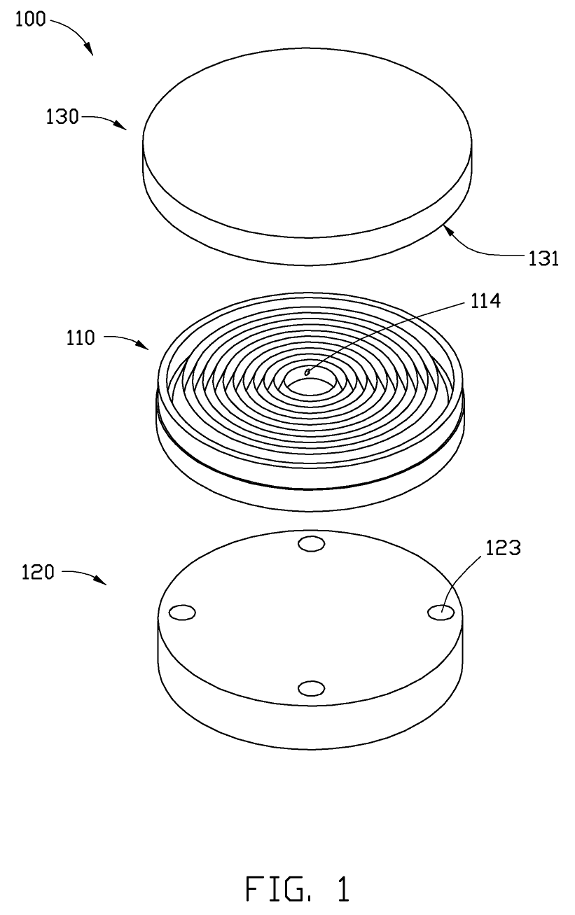

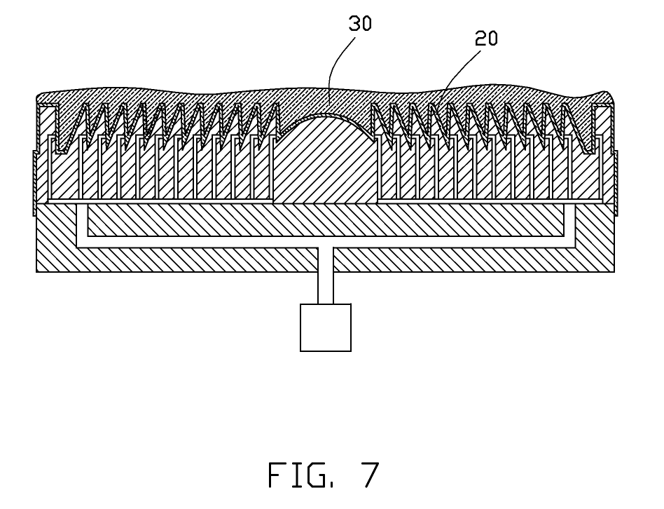

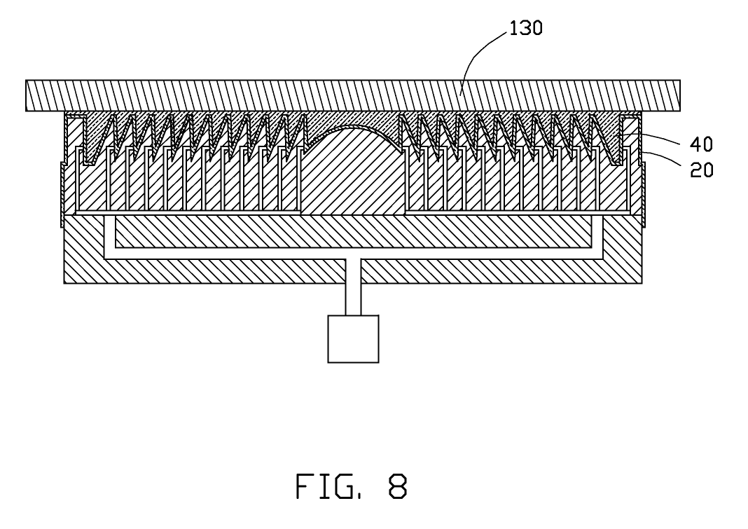

Referring to FIG. 1, a mold 100, according to one exemplary embodiment, is configured for manufacturing a Fresnel lens 40 (see FIG. 8). The mold 100 includes a mold core 110, a carrying holder 120, and a press mold plate 130. The mold core 110 is supported by the carrying holder 120. The press mold plate 130 is movable toward the mold core 110 to press a hot molding material 30 (see FIG. 7) to form the Fresnel lens 40.

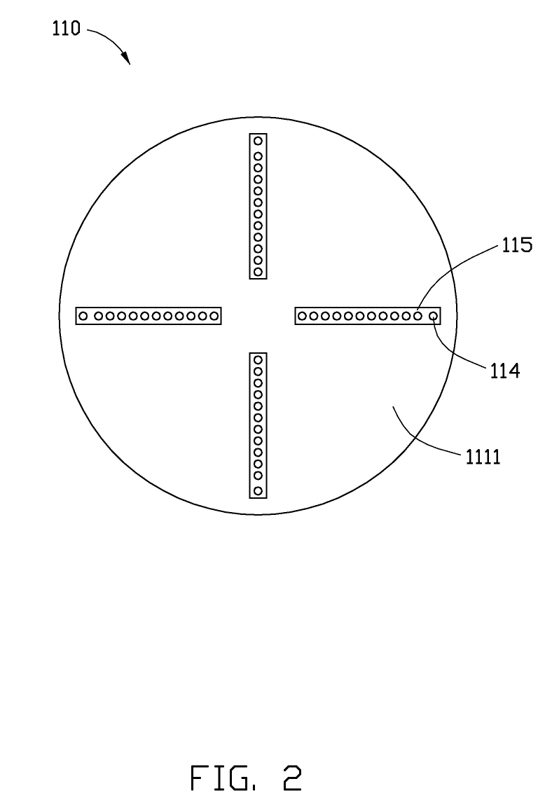

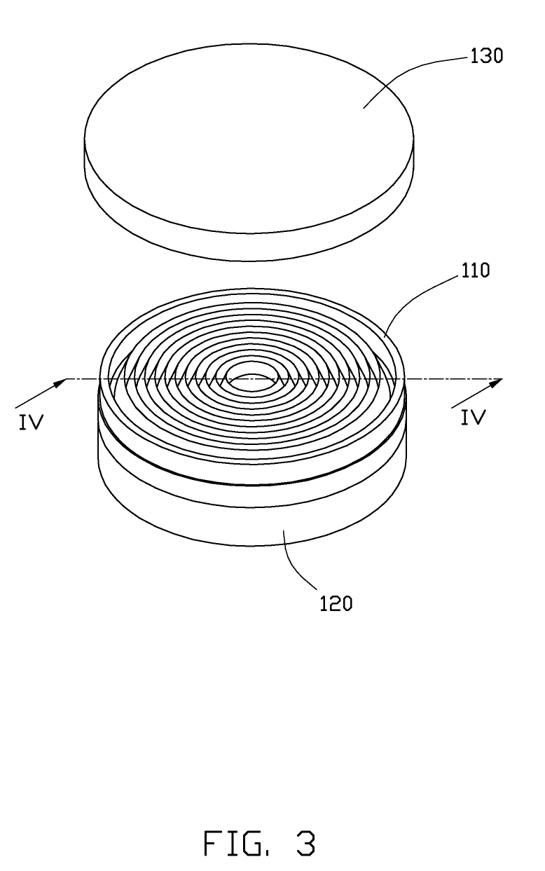

Also referring to FIGS. 2-4, the mold core 110 includes a bottom side surface 1111 facing the carrying holder 120 in operation and a top side surface 1112 facing the press mold plate 130. The mold core 110 is used for molding the Fresnel lens 40 and includes a substrate 111. The substrate 111 defines a molding structure 112 that protrudes upwards from the top side surface 1112. The molding structure 112 is designed so as to be complementary to the Fresnel lens 40.

In particular, the substrate 111 is substantially a circular plate. The molding structure 112 is defined in the top side surface 1112 generally at the center thereof. The molding structure 112 includes a central lens molding portion 1121, an annular prisms molding portion 1122, and a periphery molding portion 1123. The central lens molding portion 1121 is a spherical or aspherical protrusion protruding upwards from the top side surface 1122, generally at the center thereof. The central lens molding portion 1121 is configured for molding a central lens portion 1121 of the Fresnel lens 40. The prisms molding portion 1122 surrounds the central lens molding portion 1121 and includes a set of concentric annular protrusions 1124. The prisms molding portion 1122 is configured for molding the set of concentric annular prisms of the Fresnel lens 40. The periphery molding portion 1123 is positioned around the prisms molding portion 1122 and is configured for molding the periphery of the Fresnel lens 40.

The cross-section of each of the annular protrusions 1124 is triangle pointing upward from the top side surface 1112. Each annular protrusion 1124 includes an upright surface 1125 substantially perpendicular to the top side surface 1112 and an inclined surface 1126 inclining away from the central axis of the mold core 110. Each upright surface 1125 is positioned more adjacent to the central lens molding portion 1121 than the inclined surface 1126. Each upright surface 1125 directly connects an adjacent inclined surface 1126 of the annular protrusion 1124, forming a sharp-angle groove therebetween. The periphery molding portion 1123 includes an inner side surface 1127 perpendicular to the top side 1112.

The substrate 111 defines a number of through holes 114 in each of upright surface 1125, adjacent to the top side surface 1122, and running through the substrate 111 to the bottom side surface 1111. The through holes 114 are configured for drawing air from the upright surface 1125 to the bottom side surface 1111. Apertures of the through holes 114 are less than about 50 micrometers and may be in a range from about 10 micrometers to about 50 micrometers. As shown in FIG. 2, in the embodiment, each upright surface 1125 has four through holes 114 defined therein and equidistantly arranged therearound, and as shown in FIG. 2, four rows of the through holes 114 are arranged in the bottom side surface 1111. The through holes 114 run through the substrate 111. The inner side surface 1127 of the periphery molding portion 1123 also defines four through holes 114, adjacent to the top side surface 1112 and running through the substrate 111 to the bottom side surface 1111 of the mold core 110. The four through holes 114 in each upright surface 1125 have the same orientation angle and distance from the center axis of the mold core 110.

Each of the through holes 114 includes a first part 1141 and a second part 1142. Each first part 1141 perpendicularly extends from the upright surface 1125 to the interior of the annular protrusion 1124. Each second part 1142 perpendicularly extends from an end of the corresponding part 1141 away from the upright surface 1125 to the bottom side surface 1111. However, the configuration of the through holes 114 should not be limited to this embodiment. Alternatively, each of the through holes 114 may be set as arced holes or other suitable configurations between the upright surface 1125 and the bottom side surface 1111 of the substrate 111.

The substrate 111 also defines an annular, shallow pumping groove 115 in the bottom side surface 1111 corresponding to the rows of through holes 114. The pumping groove 115 communicates with all the through holes 114 in the corresponding row.

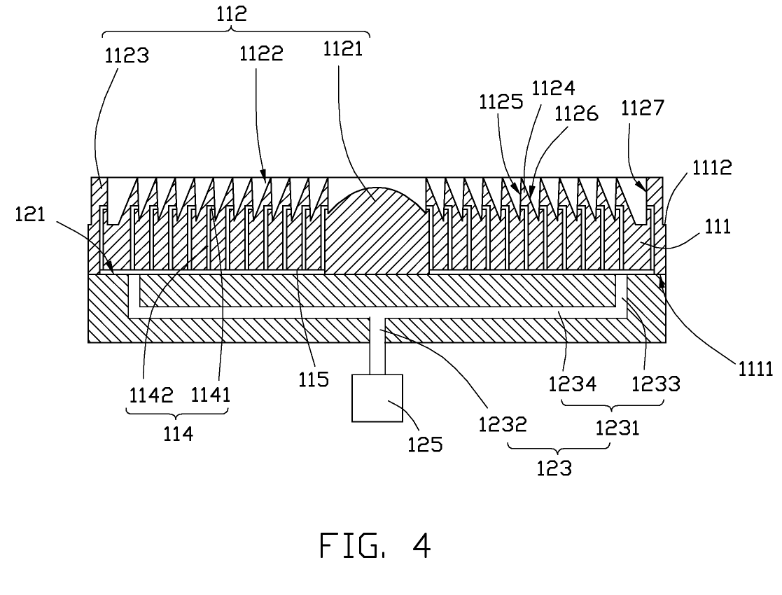

The carrying holder 120 is a circular plate in the embodiment and includes a top surface 121. The top surface 121 is shaped and sized corresponding to the bottom side surface 1111 so that the bottom side surface 1111 of the substrate 111 can be fittingly supported the top surface 121. The carrying holder 120 defines a number of pumping holes 123 in the top surface 121 that communicate with the pumping groove 115 and run through the carrying holder 120 to a bottom surface (unshown) of the carrying holder 120. The pumping holes 123 include a number of a first path 1231 and a second path 1232. As shown in FIG. 4, four first paths 1231 in the carrying holder 120 communicate with the pumping groove 115. The four first paths 1231 are communicated with the second path 1232 which extends to the bottom surface.

Each of the first paths 1231 includes a perpendicular part 1233 and a parallel part 1234. The perpendicular part 1233 communicates with the pumping groove 115, and extends from the top surface 121 to the carrying holder 120, which is perpendicular to the top surface 121. The parallel part 1234 is parallel to the top surface 121. The four parallel parts 1234 of the first paths 1231 communicate with the second path 1232.

The pumping groove 115 may be disposed in the mold core 110 or the top surface 121 of the carrying holder 120 for drawing air from the through holes 114 to the first paths 1231. If the through holes 114 could draw air directly to the first paths 1231, the pumping groove 115 may not be needed. The second paths 1232 are disposed on any position where they can achieve purpose of drawing air from the first paths 1231.

The mold 100 may further include a pumping device 125 connected with the pumping holes 123 to draw air from the through holes 114 and the pumping holes 123.

In order to avoid air leaking between the top surface 121 and the bottom side 1111, a sealing ring could be used between the mold core 110 and the carrying holder 120.

The press mold plate 130 is used to press the melt molding material on the top side 1112 to manufacture products. The press mold plate 130 includes a pressing surface 131. The area of the pressing surface 131 is larger than that of the top side 1112. The shape of the pressing surface 131 is designed so as to be complementary to a shape of the Fresnel lenses 40. As shown in FIG. 1, the shape of the pressing surface 131 is round.

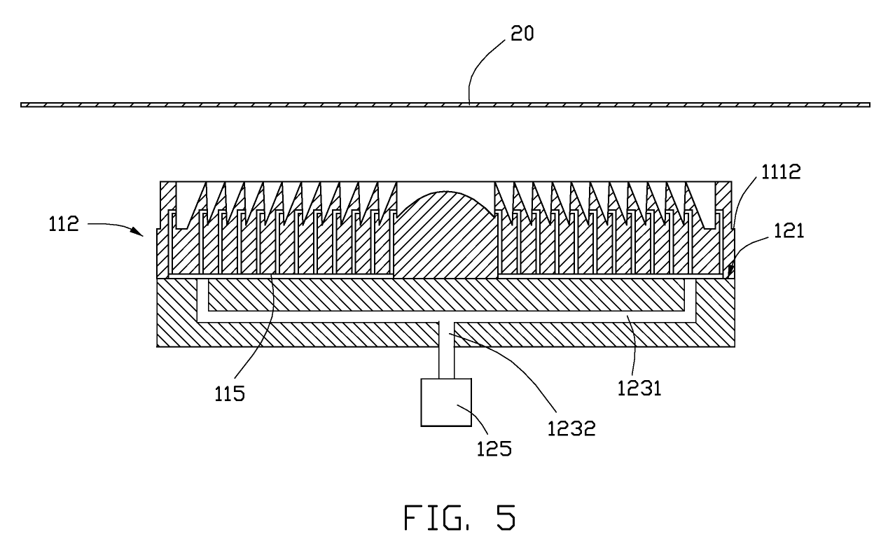

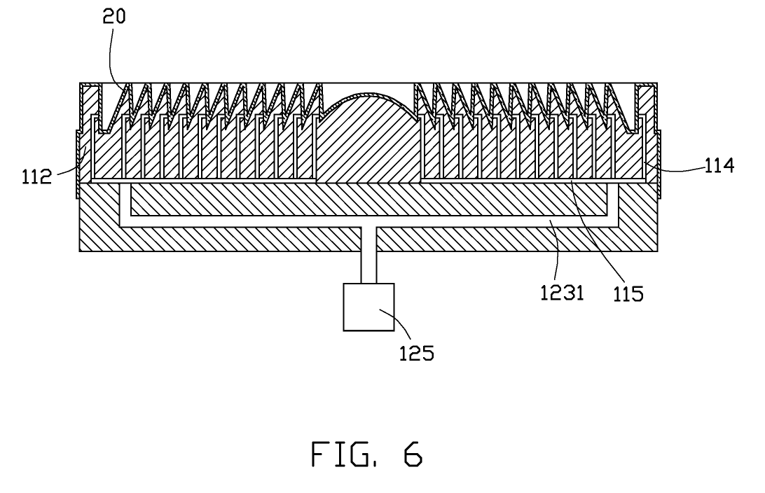

FIGS. 5-8 show a working procedure for manufacturing the Fresnel lens by using the mold 110. FIG. 5 shows setting the separation membrane 20 on surface of the molding structure 112. FIG. 6 shows that the separation membrane 20 fully contacts with the molding structure 112 of the mold core 120 after pumping air between the molding structure 112 and separation membrane 20. The thickness of the separation membrane 20 is 5 microns to 20 microns, and better 10 microns. The material of the separation membrane 20 is polymethylpentene. After the pumping device 125 drawing air between the surface of the molding structure 112 and the separation membrane 20, air flows to the top surface 121 and the bottom side 1111 via the through holes 114, and then flows out of the mold 110 via the pumping holes 123. In this way, the separation membrane 20 fully contacts with the molding structure 112, and the shape of the separation membrane 20 is the same shape as the molding structure 112.

FIG. 7 shows the melted molding material 30 injected into the mold core 120, and FIG. 8 shows a Fresnel lens 40 formed by pressing the melted molding material 30 via the press mold plate 130 of the mold 100. After setting the melted molding material 30 on the separation membrane 20, the Fresnel lenses 40 is produced by pressing the melted molding material 30 via the press mold plate 130 until the pressing surface 131 contacts the melted molding material 30, and solidifies the melted molding material 30. The melted molding material 30 may be made of epoxy Resin or phenolic resin.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the present disclosure.

1. A mold for manufacturing a Fresnel lenses, the mold comprising:
a carrying holder, and a mold core comprising a bottom side surface adjacent to the carrying holder and a top side with a molding structure,
wherein the mold core further comprises a number of through holes connected between the molding structure and the bottom side surface, and the carrying holder further comprises a number of pumping holes connected with the through holes.

2. The mold according to claim 1, further comprising a pumping device for drawing air via the through holes and the pumping holes.

3. The mold according to claim 2, wherein the pumping holes comprise a number of first paths connected with the through holes and a second path connected to the pumping device.

4. The mold according to claim 3, wherein the molding structure further comprises a plurality of concentric annular protrusions, at least one of the through holes extends from each of the annular protrusion to the bottom side surface of the mold core.

5. The mold according to claim 4, wherein the mold core is circular plate shaped, each of the annular protrusions comprises an upright surface and an inclined surface inclining away from a central axis of the mold core, each upright surface directly connects an adjacent inclined surface of an adjacent annular protrusion and forms a sharp-angle groove therebetween, the through holes are defined in each of upright surface running through the mold core to the bottom side surface.

6. The mold according to claim 5, wherein the through holes set in each upside surface have the same orientation angle and distance from the center axis of the mold core.

7. The mold according to claim 6, wherein all the through holes in all upright surfaces are set along one or more beelines perpendicular to the center axis of the mold core.

8. The mold according to claim 5, wherein the carrying holder further comprises a top surface touched with the bottom side of the mold core, the top surface of the carrying holder or the bottom side of the mold core includes a pumping groove, the pumping groove communicates with the through holes and the pumping holes.

9. The mold according to claim 5, wherein the mold further comprises a press mold plate comprising a pressing surface for pressing a molding material on the molding structure to mold a Fresnel lens.

10. The mold according to claim 5, wherein a diameter of each the through hole is between 10 micrometers and 50 micrometers.

11. A method for manufacturing a Fresnel lens, the method comprising:
providing a mold comprising a carrying holder and a mold core comprising a bottom side surface adjacent to the carrying holder, a top side with a molding structure, and a plurality of through holes connected between the molding structure and the bottom side surface, wherein the carrying holder further comprises a plurality of pumping holes connected with the through holes;
setting a separation membrane on surface of the molding structure;
pumping air between the molding structure and the separation membrane to make the separation membrane contact securely with the molding structure;
pressing a melted molding material placed on the molding structure via a press mold plate until a pressing surface of the press mold plate contacts the melted molding material; and
solidifying the melted molding material to get a Fresnel lenses.
